(19) United States
(12) Patent Application Publication
(10) Pub. No.: US 2005/0121553 A1
(43) Pub. Date: Jun. 9, 2005

(54) Toy radio-controlled helicopter

(76) Inventors: Kunikazu Isawa, Tokyo (JP); Yasuhiko Sugawara, Tokyo (JP)

Correspondence Address: JORDAN AND HAMBURG LLP, 122 EAST 42ND STREET, SUITE 4000, NEW YORK, NY, 10168, US

(21) Appl. No.: 10/955,342

(22) Filed: Sep. 29, 2004

(30) Foreign Application Priority Data
Nov. 20, 2003 (JP) 2003-390390

(51) Int. Cl. B64C 27/00

(52) U.S. Cl. 244/17.19; 446/36

(57) ABSTRACT

A toy radio-controlled helicopter includes: a main rotor, attached on the top of a fuselage and driven by a motor incorporated in the fuselage; a tail rotor that is driven by the motor and is attached to a tail unit provided at the end of a horizontally elongated boom that is extended from the rear of the fuselage; right and left movable wings, attached to the right and left sides of the fuselage below the main rotor, that can be rotated by respective actuators incorporated in the fuselage; and a receiver incorporated in the fuselage to control the operations of the motor and the actuators.

### BACKGROUND OF THE INVENTION

1. Field of the Invention

The present invention relates to a toy radio-controlled helicopter for which aeronautical maneuvers, such as forward and reverse flight and turns, can be easily controlled.

2. Related Background Art

Conventionally, for a common toy radio-controlled helicopter, a motor incorporated in the fuselage of the toy rotates a main rotor, attached to the top of the fuselage, and a tail rotor, which is attached to the end of a boom extending from the rear of the fuselage and which neutralizes reactive torque of the fuselage produced by the rotation of the main rotor. Further, a mechanism for tilting the rotating face of the main rotor of an aircraft to the front or the rear, and to the right or the left, is provided to permit the aircraft to fly forward or in reverse and to perform turns to the right or left. One well known toy radio-controlled helicopter, for which a tail rotor is not required, has a tail unit attached at the rear of the fuselage that generates lift in a direction that neutralizes the reactive torque of the fuselage produced by the main rotor during the flight (see, for example, patent document 1: JP-A-Hei 8-103571 (pp. 1-3 and FIGS. 1 to 5).

However, since for a conventional toy radio-controlled helicopter mechanisms for tilting the rotating face of the main rotor to the front or rear and to the right or left are provided that permit a radio controller to be used to control the flight of the aircraft, the structure and the control operation are complicated, and respectively increase the overall costs and render the remote piloting operation too difficult for a beginner to handle easily. Furthermore, although a tail rotor is not required and a simplified mechanism can be provided for a toy radio-controlled helicopter having a tail unit, attached to the rear of its fuselage, that generates lift to neutralize the reactive torque resulting from the rotation of the main rotor, such am aircraft may become unstable when forward flight is resumed while hovering, or when taking off, because lift for neutralizing the reactive torque is not generated at the tail unit.

### SUMMARY OF THE INVENTION

To resolve these problems, it is one objective of the present invention to provide a toy radio-controlled helicopter having a configuration that includes a simplified piloting mechanism, for performing a complicated control operation for stabilizing flight performance, that can be manufactured at a low cost and that can easily be controlled, even by a beginner.

To achieve this objective, according to a first aspect of the invention, a toy radio-controlled helicopter comprises:
a main rotor, attached to the top of a fuselage and driven by an incorporated motor;
a tail rotor, attached to a tail unit at the end of a horizontal, elongated boom extending from the rear of the fuselage, that is driven by the motor;
a right moveable wing and a left movable wing, so attached to right and left side faces of the fuselage, below the main rotor, as to be movable by an actuator unit incorporated in the fuselage; and
a receiver, incorporated in the fuselage, for controlling the operations of the motor and the actuator. Since the right and left movable wings can be rotated, a simple mechanism can be used to perform a complicated operation, the flight performance can be stabilized, the configuration can be simplified and manufactured at a low cost, and even a beginner can perform the piloting operation.

According to a second aspect of the invention, as the actuator unit, a right actuator and a left actuator are incorporated in the fuselage and independently rotate the right movable wing and the left movable wing. Since the right and left actuators independently control the right and left movable wings, movement of the wings can be freely controlled.

According to a third aspect of the invention, as the actuator unit, one actuator, incorporated in the fuselage, employs a link mechanism to rotate the right and left movable wings in opposite directions. With this arrangement, only one actuator need be provided to control the rotation of the right and left wings.

According to a fourth aspect of the invention, the right and left movable wings are mounted on respectively included horizontally arranged shafts, extending inward from the right and left sides of the fuselage, that are coupled with the actuator unit, so that the right and left wings attached to the shafts are rotated from the vertical and are tilted to the front or to the rear. Since the right and left wings are rotated from the vertical so that they are tilted to the front or rear, a fore or aft displacement force is exerted on the aircraft by an induced flow of air produced by the main rotor, and the airframe can be moved forward or to the rear, or rotated to the right or left.

According to a fifth aspect of the invention, a rear wing is formed at the aft end of the tail unit to generate lift in the airflow produced by the rotation of the tail rotor. Since during flight, in the airflow produced by the tail rotor, the rear wing on the tail unit generates lift, the aft end of the tail unit is raised while the front, distal end of the fuselage is lowered, and the aircraft can move forward with the entire rotating face of the main rotor slightly tilted.

According to a sixth aspect of the invention, the tail rotor attached to the tail unit is tilted, rather than horizontal, so as to employ a horizontal component of the propulsive force exerted by the rotation of the tail rotor to neutralize, for the fuselage, the reactive torque resulting from the rotation of the main rotor, and so as to employ a vertical component of the same force to raise the aft end of the tail unit and lower the front, distal end of the fuselage. With this arrangement, the aircraft can move forward with the front, distal end of the fuselage lowered and the aft end of the tail unit raised, and the entire rotating face of the main rotor tilted slightly to the front.

Through the rotation of right and left movable wings attached to the right and left side faces of the fuselage of a toy radio-controlled helicopter, the configuration can be simplified and can be manufactured at a low cost, an uncomplicated mechanism can be employed to perform a complex control operation, the flight performance can be stabilized, and the piloting operation can be performed easily, even by a beginner.

### BRIEF DESCRIPTION OF THE DRAWINGS

FIG. 1 is a perspective view of a toy helicopter according to a first embodiment of the present invention;

FIG. 2 is a plan view for explaining a driving system for the toy helicopter according to the first embodiment of the invention;

FIG. 3 is a side view for explaining the driving system of the toy helicopter according to the first embodiment;

FIG. 4 is a front view of the driving system of the toy helicopter according to the first embodiment of the invention;

FIG. 5 is a block diagram for explaining an operation for controlling the toy helicopter according to the first embodiment of the invention;

FIG. 6 is a diagram for explaining the forward flight of the toy helicopter according to the first embodiment of the invention;

FIG. 7 is a diagram for explaining the rearward flight of the toy helicopter according to the first embodiment of the invention;

FIG. 8 is a diagram for explaining the right rotational movement of the toy helicopter according to the first embodiment of the invention;

FIG. 9 is a diagram for explaining the left rotational movement of the toy helicopter according to the first embodiment of the invention;

FIG. 10 is a perspective view of a toy helicopter according to a second embodiment of the invention;

FIG. 11 is a rear view for explaining an example tail unit for the toy helicopter according to the present invention; and

FIG. 12 is a rear view for explaining another example tail unit for the toy helicopter according to the present invention.

### DETAILED DESCRIPTION OF THE PREFERRED EMBODIMENTS

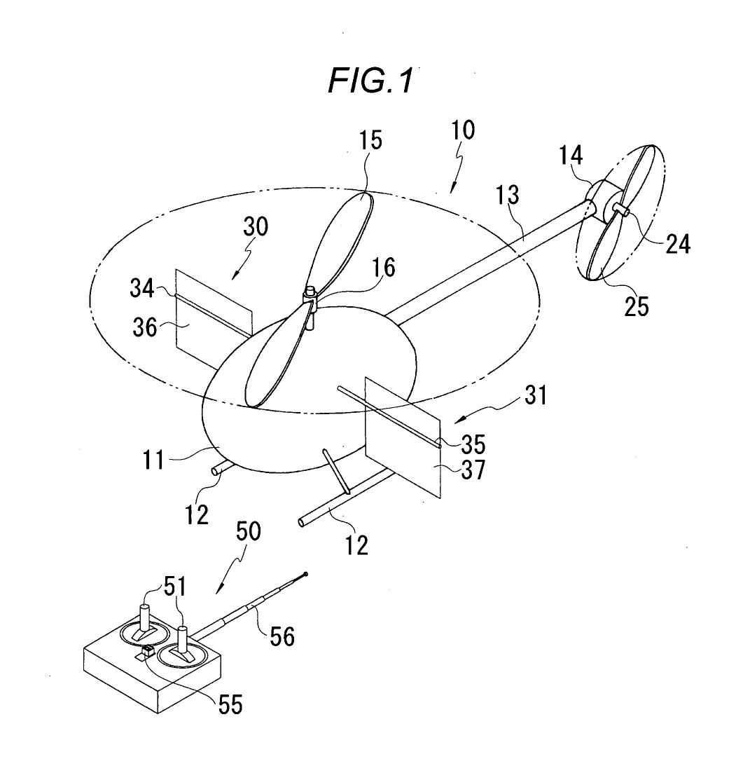

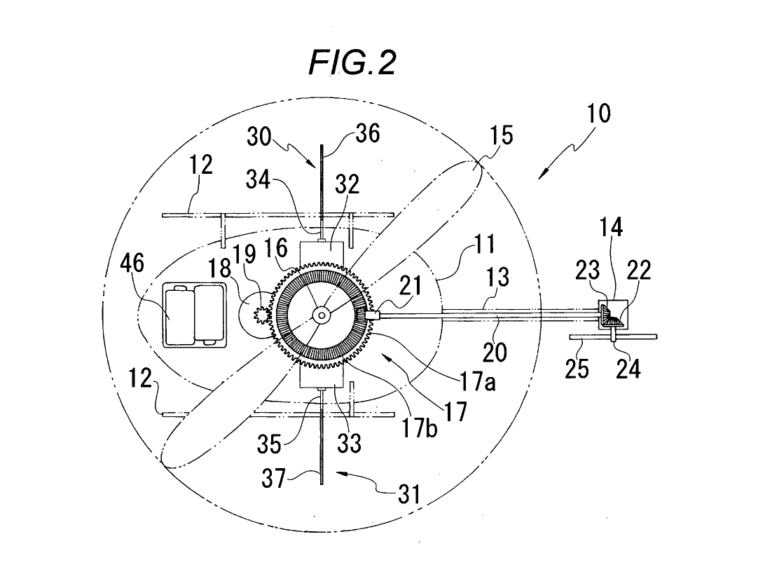

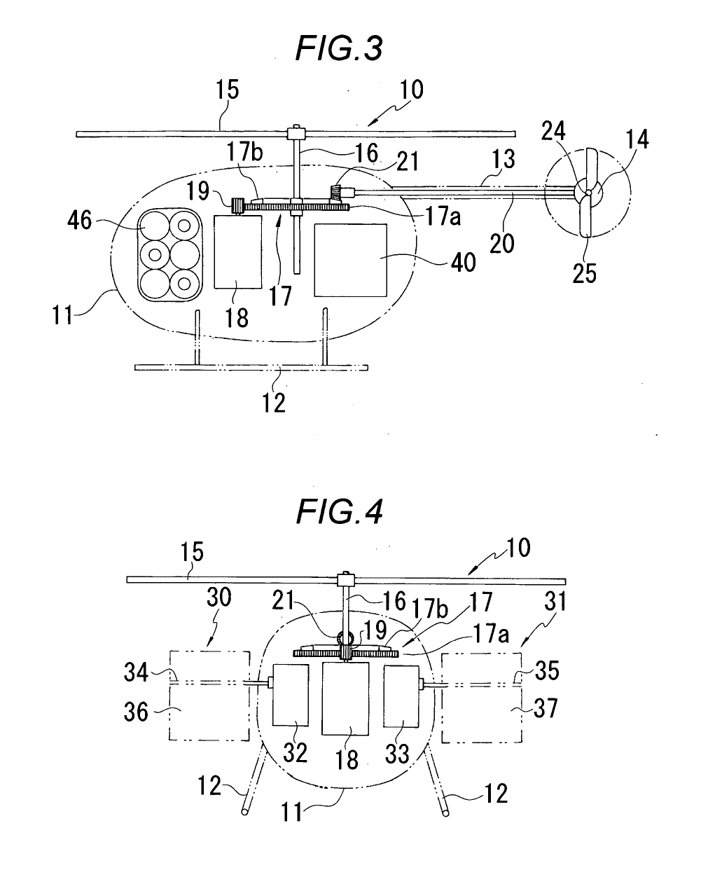

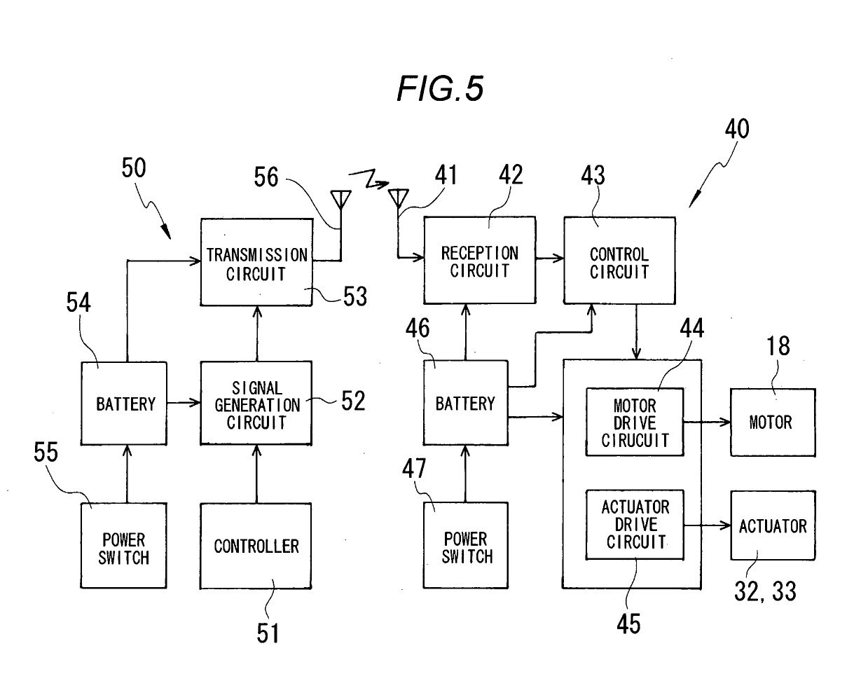

The present invention will now be described more specifically by referring to a first embodiment. FIGS. 1 to 5 are diagrams for explaining a toy radio-controlled helicopter according to the first embodiment. FIG. 1 is a plan view for explaining the driving system of the toy helicopter, FIG. 2 is a plan view for explaining the driving system of the toy helicopter, FIG. 3 is a side view for explaining the driving system of the toy helicopter, FIG. 4 is a front view for explaining the driving system of the toy helicopter, and FIG. 5 is a block diagram for explaining an operation performed to control the toy helicopter.

For a toy helicopter 10 according to this embodiment, a main rotor 15 is attached to the top of a fuselage 11; landing members 12 are attached to the lower portion of the fuselage 11 for landing on the ground, for example; a horizontally elongated boom 13 is extended from the rear of the fuselage 11; a tail rotor 25 is attached to a tail unit 14 provided at the end of the boom 13; a right moveable wing 30 and a left movable wing 31 are rotatably attached to the right and left side faces of the fuselage 11, below the main rotor 15; a receiver 40 is incorporated in the fuselage 11 to receive control signals from a transmitter 50; a motor 18 is incorporated in the fuselage 11 to drive the main rotor 15 and the tail rotor 25; and a right actuator 32 and a left actuator 33 are incorporated in the fuselage 11 to respectively drive the right and left movable wings 30 and 31 and permit aeronautical maneuvers to be freely controlled.

The fuselage 11, which is composed of a light-weight material such as plastic, has a hollow, slightly elongated oval shape, and the landing members 12, which are composed of the same plastic material and which are provided for landing on a plane surface, such as the ground, are attached to the lower right and left sides of the fuselage 11. The end of a main rotor shaft 16, which is vertically positioned, substantially in the center of the fuselage 11, extends upward from the inside of the fuselage 11. The main rotor 15, which is made, for example, of plastic and which is used for aeronautical flight, is fitted over the upper end of the main rotor shaft 16, and within the fuselage 11, substantially at the center of the main rotor shaft 16, a gear unit 17 is attached. The gear unit 17 includes a spur gear 17a, formed around its outer circumference, and a bevel gear 17b, formed on its upper, horizontal side face. The spur gear 17a engages a pinion 19, which is fitted over the output shaft of the motor 18 incorporated in the fuselage 11, so that as the output shaft of the motor 18 turns, the spur gear 17a turns the main rotor shaft 16 and the main rotor 15 is rotated. It should be noted that the main rotor 15, when rotated by the motor 18, provides sufficient lift to raise the fuselage 11, the entire aircraft, and to perform flight.

The boom 13, which linearly is hollow and is composed, for example, of plastic, is integrally attached to the rear of the fuselage 11. One end of the boom 13 communicates with the interior of the fuselage 11, while the other end extends aft, horizontally. The tail unit 14, which is shaped like a case, is attached to the end of the boom 13, and a rotatable, elongated tail rotor shaft 20 is inserted into the hollow portion of the boom 13. One end of the rail rotor shaft 20 is extended into the fuselage 11, and a bevel gear 21 fitted over that end engages the bevel gear 17b provided for the gear unit 17. The other end of the tail rotor shaft 20 is extended into the tail unit 14, where a bevel gear 23, arranged inside the tail unit 14, is fitted over it. The bevel gear 23 engages a bevel gear 22 in the tail unit 14 and one end of a short, rotary shaft 24, provided for the bevel gear 22, is extended outward, horizontally, from the tail unit, and the tail rotor 25 is attached to this extended end. Thus, as the motor 18 is operated and the gear unit 17 and the bevel gear 17b are rotated by the spur gear 17a that engages the pinion 19, the tail rotor shaft 20 is turned by the bevel gear 21 that engages the bevel gear 17b. Then, the shaft 24 is turned by the bevel gear 22 that engages the bevel gear 23 attached to one end of the tail rotor shaft 20. It should be noted that, as will be described later in detail, the shaft 24 has a function whereby, when driven by the motor 18, a force is generated to neutralize the reactive torque to which the fuselage 11 is subjected as a result of the rotation of the main rotor 15.

The right moveable wing 30 and the left movable wing 31 are rotatably attached to the right and left sides of the fuselage 11 below the main rotor 15. The right movable wing 30 and the left movable wing 31 respectively include shafts 34 and 35, the ends of which are horizontally projected outward from the right and left side faces of the fuselage 11, and a right wing 36 and a left wing 37, which are attached to the projected portions of the shafts 34 and 35. Inside the fuselage 11, the other ends of the shafts 34 and 35 are connected to the incorporated right and left actuators 32 and 33. The right and left wings 36 and 37 are, for example, thin, flat rectangular plates formed of plastic, and have sufficient transverse width to receive the airflow produced by the main rotor 15 above, and are small enough that they do not contact the fuselage 11 or the landing members 12 when they are rotated by the shafts 34 and 35. Further, the right and left wings 36 and 37 are so attached to the fuselage 11 that their surfaces are vertical when they are not driven by the right and left actuators 32 and 33. Thus, the right and left movable wings 30 and 31 are pivoted by the right and left actuators 32 and 33, and from the vertical, can be independently tilted to the front or the rear by the shafts 34 and 35 to the front or rear

Further, the fuselage 11 also includes the receiver 40 for receiving radio control signals from the transmitter 50, and a battery 46 for supplying power to the receiver 40, the motor 18 and the right and left actuators 32 and 33.

The receiver 40 includes: an antenna 41; a reception circuit 42, for receiving radio control signals from the transmitter 50; a control circuit 43, for generating control signals based on the signals received by the reception circuit 42; a motor drive circuit 44, for driving the motor 18 based on the control signals output by the control circuit 43; and an actuator drive circuit 45, for driving the right and left actuators 32 and 33. With this arrangement, when a power switch 47 that is attached to the fuselage 11 and is used for control is turned on, power is supplied by the battery 46 to the reception circuit 42, the control circuit 43, the motor drive circuit 44 and the actuator drive circuit 45. The transmitter 50 includes: a controller 51, having control levers for controlling the heading, such as rising or descending, forward or rearward flight, or turns; a signal generation circuit 52, for generating a control signal in accordance with the manipulation of the controller 51; and a transmission circuit 53 for transmitting, as a radio signal, the control signal generated by the signal generation circuit 52. With this arrangement, when a power switch 55 is turned on, power is supplied by a battery 54 to the signal generation circuit 52 and the transmission circuit 53.

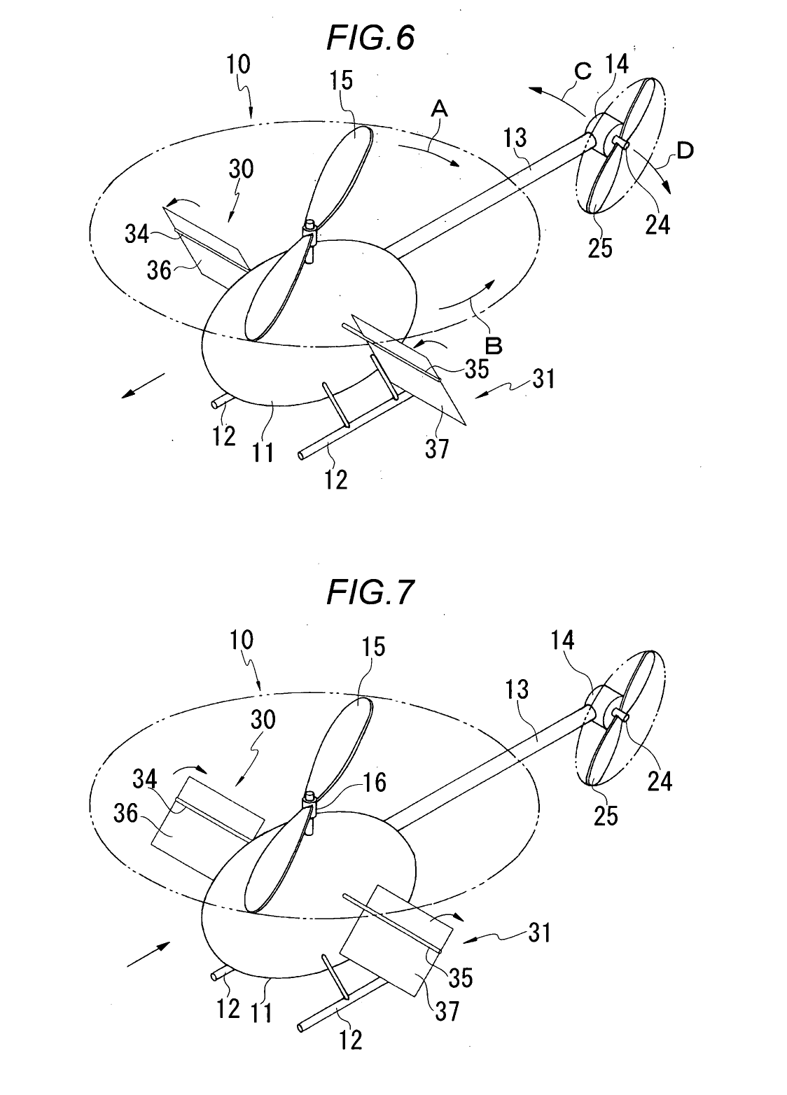

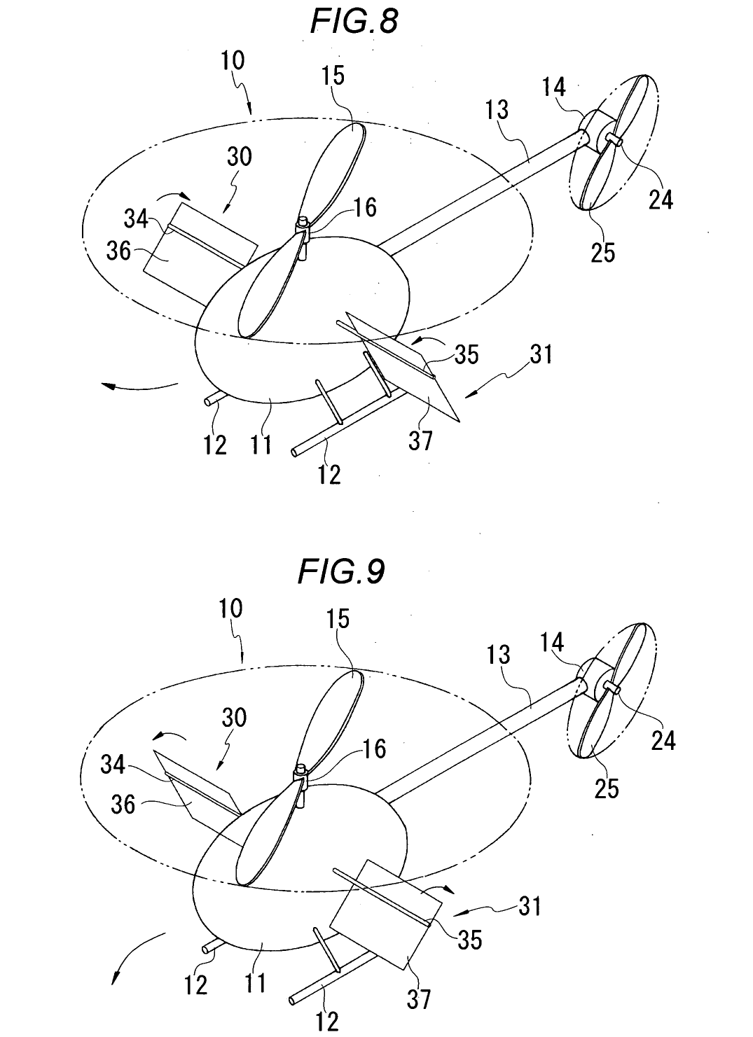

The operation of the thus arranged toy helicopter 10 will now be described. FIGS. 6 to 9 are diagrams for explaining the operation of the toy helicopter 10. FIG. 6 is a diagram for explaining the forward flight of the toy helicopter 10, FIG. 7 is a diagram for explaining the rearward flight of the toy helicopter 10, FIG. 8 is a diagram for explaining a right turn performed by the toy helicopter 10, and FIG. 9 is a diagram for explaining a left turn performed by the toy helicopter 10.

In order to operate the toy helicopter 10, first, the power switch 47 provided for the fuselage 11 is turned on, and the lower portions of the landing members 12 are placed on flat ground, for example, to prepare for the takeoff of the fuselage 11. Then, when the power switch 55 of the transmitter 50 is turned on, and the control lever of the controller 51 is manipulated, the signal generation circuit 52 generates a control signal corresponding to the manipulation, and the transmission circuit 53 transmits a radio control signal through an antenna 56. The control signal transmitted by the transmitter 50 is received, through the antenna 41, by the reception circuit 42 of the receiver 40 that is incorporated in the fuselage 11 of the toy helicopter 10. The control signal, which has been transmitted from the transmitter 50 and received by the reception circuit 42, is transmitted to and amplified by the control circuit 43. The control circuit 43 generates a signal obtained by changing the pulse width and the cycle of the resultant signal, and outputs this signal to the motor drive circuit 44. The motor drive circuit 44 generates a drive signal to drive the motor 18, and based on this drive signal, the motor 18 starts to rotate. At this time, in accordance with a rising instruction signal, the right and left wings 36 and 37 of the right and left moveable wings 30 and 31 are maintained in the vertical state by the right and left actuators 32 and 33. The rotation of the motor 18 is transmitted by the pinion 19, through the spur gear 17a and the main rotor shaft 16, to the main rotor 15, which then starts rotating. At the same time, the rotation of the motor 18 is also transmitted by the pinion 19, through the bevel gear 17b, the bevel gear 21, the tail rotor shaft 20, the bevel gear 23 and the shaft 24, to the tail rotor 25, which then starts rotating. When the main rotor 15 and the tail rotor 25 are rotated by the motor 18, the main rotor 15 generates a downward airflow while the tail rotor 25 exerts a force for neutralizing the reactive torque that is generated by the rotation of the main rotor 15. As a result, the fuselage 11 takes off from the land and begins to rise.

When the fuselage 11 has risen to a predetermined height, and when the control lever of the controller 51 is manipulated for forward flight, as is described above, the transmitter 50 transmits a forward flight control signal that the reception circuit 42 receives. Similarly, the actuator drive circuit 45 generates a drive signal, and the right and left actuators 32 and 33 of the right and left moveable wings 30 and 31 are driven in accordance with this drive signal. Then, as is shown in FIG. 6, the shafts 34 and 35 are rotated, and accordingly, the right and left wings 36 and 37 are tilted from the vertical toward the front. The airflow produced by the main rotor 15, exerts a propulsive force on the right and left wings 36 and 37, which are tilted to the front, and the fuselage 11 begins to fly forward. When, as is shown in FIG. 6, the main rotor 15 is rotated in a direction indicated by an arrow A, a reactive torque, generated in the direction indicated by an arrow B, acts on the fuselage 11, while as the tail rotor 25 is rotated an antitorque is generated, in the direction indicated by an arrow D, to neutralize a an torque that occurs in the tail unit 14 in the direction indicated by an arrow C, which corresponds to the direction indicated by the arrow B. As a result, the fuselage 11 is stably operated without spinning.

When the control lever of the controller 51 is manipulated for rearward flight, as is described above, the transmitter 50 transmits a rearward flight control signal that the reception circuit 42 receives. Similarly, the actuator drive circuit 45 generates a drive signal, and the right and left actuators 32 and 33 of the right and left moveable wings 30 and 31 are driven. Then, as is shown in FIG. 7, the shafts 34 and 35 are rotated, and accordingly, the right and left wings 36 and 37 are tilted from the vertical to the rear. The airflow produced by the main rotor 15, exerts a propulsive force on the right and left wings 36 and 37, which are tilted to the rear, and a rearward movement force is exerted on the right and left wings 36 and 37. As a result, the fuselage 11 begins to move to the rearward.

When the control lever of the controller 51 is manipulated for a right turn, as is described above, the transmitter 50 transmits a right turn control signal that is received by the reception circuit 42. Similarly, the actuator drive circuit 45 generates a drive signal, and the right and left actuators 32 and 33 of the right and left movable wings 30 and 31 are driven in accordance with this drive signal. Then, as is shown in FIG. 8, the shafts 34 and 35 are rotated, and the right wing 36 is to the rear from the vertical position, while the left wing 37 is tilted to the front from the vertical position. The airflow produced by the main rotor 15 exerts a rearward force on the right wing 36 and a propulsive force on the left wing 37. As a result, the entire fuselage 11 starts a right turn.

When the control lever of the controller 51 is manipulated for a left turn, as is described above, the transmitter 50 transmits a left turn control signal that the reception circuit 42 receives. Similarly, the actuator drive circuit 45 generates a drive signal, and the right and left actuators 32 and 33 of the right and left movable wings 30 and 31 are driven in accordance with this drive signal. Then, as is shown in FIG. 9, the shafts 34 and 35 are rotated, and the right wing 36 is tilted from the vertical position to the front, while the left wing 37 is tilted from the vertical position to the rear. The airflow produced by the main rotor 15 exerts a propulsive force on the right wing 36 and a rearward force on the left wing 37. As a result, the entire fuselage 11 starts a left turn.

For the toy helicopter 10 with the above described configuration, the main rotor 15 rotated by the motor 18 is provided on the top of the fuselage 11; the tail rotor 25 rotated by the motor 18 is provided at the end of the boom 13 extended from the rear of the fuselage 11; and the right and left movable wings 30 and 31 are attached on the right and left sides of the fuselage 11 and are be rotated by the right and left actuators 32 and 33 that are incorporated in the fuselage 11. The receiver 40 incorporated in the fuselage 11 receives a control signal from the transmitter 50, and the right and left actuators 32 and 33 are independently rotated to control the tilting angles of the right and left wings 36 and 37. As a result, since the airflow produced by the main rotor 15 acts on the right and left wings 36 and 37, forward flight, rearward flight and right and left turns can be performed. Since the right and left movable wings 30 and 31 are attached to the right and left sides of the fuselage 11 and are rotated by the right and left actuators 32 and 33, the structure and the control can be simplified, compared with a mechanism for tilting the rotating face of the main rotor 15, and the manufacturing costs can be reduced. Furthermore, since the right and left wings 36 and 37 are provided for the right and left sides of the fuselage 11, stabilized flight can be attained. Further, the remote piloting operation can be even more simplified by using the control lever of the controller 51, and even beginner can easily control the aircraft. In addition, according to this embodiment, the same main rotor 15 as is conventionally used is attached to the end of the boom 13 extended from the rear of the fuselage 11, the aircraft can stably resume flight from the hovering state, or can stably take off.

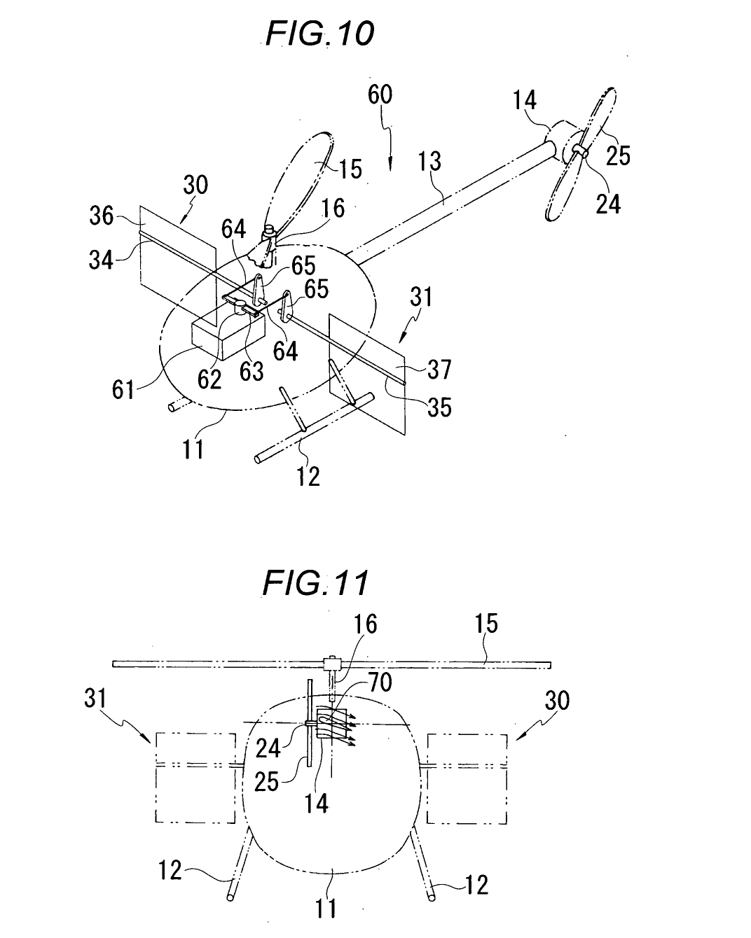

FIG. 10 is a perspective view of a toy radio-controlled helicopter according to a second embodiment of the present invention. The same reference numerals as used for the first embodiment are also employed to denote corresponding parts and members, and no further explanation for them will be given.

For a toy helicopter 60 for the second embodiment, right and left movable wings 30 and 31, provided in the same manner as for the first embodiment, are rotated by a single actuator 61 that is incorporated in a fuselage 11. In the actuator 61, a lever 63 extended horizontally is fitted in a rotary shaft 62 that is located upright in the center of the fuselage 11, and the ends of link rods 64 and 65 are connected to the right and left ends of the lever 63. Shafts 34 and 35 for the right and left movable wings 30 and 31 are extended inward into the fuselage 11, and their ends are fixed to the ends of connection rods 65 that are extended upward. The other ends of the connection rods 65 are connected to the other ends of the corresponding link rods 64. That is, the rotation of the rotary shaft 62 of the actuator 61 is transmitted at the same time to the shafts 34 and 35 from the lever 63 to the connection rods 65 and the link rods 64, which constitute a link mechanism, so that the shafts 34 and 35 are rotated in opposite directions. The other configuration is the same as that for the first embodiment.

For the thus arranged toy helicopter 60, only one actuator 61 need be employed to rotate the right and left movable wings 30 and 31, which are attached in the same manner as for the first embodiment, in order to perform a right turn or a left turn. According to this embodiment, since one actuator 61 is employed to control the right and left movable wings 30 and 31, the control operation can be simplified and the weight of the entire fuselage 11 can be reduced. Furthermore, as well as in the first embodiment, the flight maneuvers performed by the helicopter 60 can be stabilized, and the remote piloting operation can be simplified so that even a beginner can easily control the toy helicopter 60. In this embodiment, forward flight and rearward flight can not be controlled by the rotation of the right and left wings 30 and 31. However, for example, the rotating face of the main rotor 15 need only be tilted slightly to the front, so that forward flight can be performed.

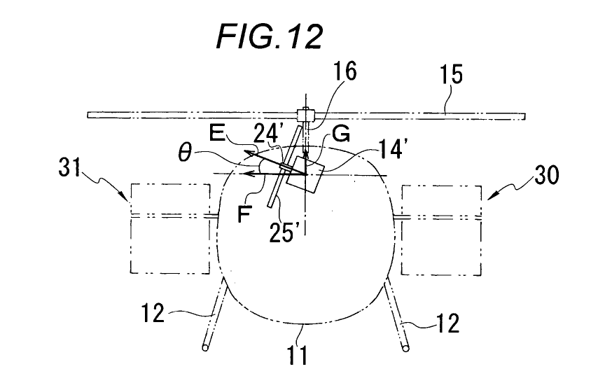

FIGS. 11 and 12 are diagrams for explaining a toy helicopter having an improved tail rotor. FIG. 11 is a rear view for explaining an example tail unit for the toy helicopter, and FIG. 12 is a rear view for explaining another example tail unit for the toy helicopter. The same reference numerals as used for the first and second embodiments are also employed to denote corresponding parts and members, and no further explanation for them will be given.

As is shown in FIG. 11, a rear wing 71 is provided at the end of the tail unit 14 for the first and second embodiments, and generates lift when an airflow is produced by the rotation of a tail rotor 24. During flight, lift is generated by the airflow produced by the tail rotor 24 as it passes over the rear wing 71 and is exerted on the tail unit 14. With this lift, the head of the fuselage 11 is lowered, the tail unit 14 is raised, and the rotating face of the main rotor 15 is tilted slightly to the front. As a result, the aircraft can move forward.

As is shown in FIG. 12, a tail rotor 25′ of a tail unit 14′, which is formed in the same manner as for the first and second embodiments, is fitted over a shaft 24′, and the shaft 24′ is tilted at an angle θ from the horizontal. As the tail rotor 25′ is rotated, a propulsive force, exerted in the direction indicated by an arrow E at the angle θ, acts on the tail unit 14′. Of the propulsion force, a horizontal component force in the direction indicated by an arrow F neutralizes the torque that is generated in the fuselage 11 by the main rotor 15, while a vertical component force in the direction indicated by an arrow G lowers the head of the fuselage 11 and raises the tail unit 14′. As a result, since the entire rotating face of the main rotor 15 is tilted slightly to the front, the aircraft can move forward.

The structures of the tail rotor shown in FIGS. 11 and 12 can be employed for the toy helicopters 10 and 60 in the first and second embodiments. Since either of the structures can be employed for the tail rotor, forward flight can be easily obtained while the head of the fuselage 11 is lowered and the tail unit is raised slightly.

For the first and second embodiments, the shapes and sizes of the fuselage 11, the boom 13, the tail unit 14 and the right and left wings 36 and 37 can be arbitrarily designated, and are not limited to those for the embodiments.

The present invention can be employed for a toy radio-controlled helicopter for which such aeronautical maneuvers as forward flight, rearward flight and turns are controlled.

1. A toy radio-controlled helicopter comprising:
a main rotor, attached to the top of a fuselage and driven by an incorporated motor;
a tail rotor, attached to a tail unit at the end of a horizontal, elongated boom extending from the rear of the fuselage, that is driven by the motor;
a right moveable wing and a left movable wing, so attached to right and left side faces of the fuselage, below the main rotor, as to be movable by an actuator unit incorporated in the fuselage; and
a receiver, incorporated in the fuselage, for controlling the operations of the motor and the actuator.

2. A toy radio-controlled helicopter according to claim 1, wherein, as the actuator unit, a right actuator and a left actuator are incorporated in the fuselage and independently rotate the right movable wing and the left movable wing.

3. A toy radio-controlled helicopter according to claim 1, wherein, as the actuator unit, one actuator, incorporated in the fuselage, employs a link mechanism to rotate the right and left movable wings in opposite directions.

4. A toy radio-controlled helicopter according to claim 1, wherein, the right and left movable wings are mounted on respectively included horizontally arranged shafts, extending inward from the right and left sides of the fuselage, that are coupled with the actuator unit, so that the right and left wings attached to the shafts are rotated from the vertical and are tilted to the front or to the rear.

5. A toy radio-controlled helicopter according to claim 1, wherein a rear wing is formed at the aft end of the tail unit to generate lift in the airflow produced by the rotation of the tail rotor.

6. A toy radio-controlled helicopter according to claim 1, wherein the tail rotor attached to the tail unit is tilted, rather than horizontal, so as to employ a horizontal component of the propulsive force exerted by the rotation of the tail rotor to neutralize, for the fuselage, the reactive torque resulting from the rotation of the main rotor, and so as to employ a vertical component of the same force to raise the aft end of the tail unit and lower the front, distal end of the fuselage.
